(19) United States
(12) Patent Application Publication
(10) Pub. No.: US 2009/0164587 A1
(43) Pub. Date: Jun. 25, 2009

(54) METHOD AND COMMUNICATION SERVER FOR GROUP COMMUNICATIONS

(75) Inventors: Edoardo Gavita, Laval (CA); Nazin Hossain, Brossard (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/962,771

(22) Filed: Dec. 21, 2007

(51) Int. Cl. G06F 15/16

(52) U.S. Cl. 709/206; 709/204

(57) ABSTRACT

A method and communication server for creating a communication group are provided, wherein the server detects a group communication, such as for example, a text-based group communication, or a voice or video based group communications. The server not only sets up the group communication toward the participants, but also creates a communication group, comprising an identifier and identities of the participants, in response to the group communication detection. Participants to the group communication receive from the server a communication group identifier, which they can store and use in order to facilitate subsequent group communications.

### TECHNICAL FIELD

The present invention relates to the area of group communications.

### BACKGROUND

The IP Multimedia Subsystem (IMS) is an architecture framework for delivery of Internet protocol IP multimedia to mobile users. It was originally designed by the wireless standards body 3^{rd} Generation Partnership Project (3GGP), and is part of the vision for evolving mobile networks beyond GSM (General System for mobile Communications). In its original formulation, 3GPP R5 (Release 5) presented an approach to deliver Internet services over GPRS (General Packet Radio Service). This vision was later updated by 3GPP, 3GPP2, and TISPAN (Telecoms & Internet converged Services & Protocols for Advanced Networks), which is a standard body of the ETSI (European Telecommunications Standards Institute) by requiring support of networks other than GPRS, such as for example WLAN (Wireless Local Area Networks), CDMA2000 (Code Division Multiple Access 2000), and fixed line.

One of such Internet services is the Instant Messaging (IM), which is the exchange of text messages through a software application in real-time. Generally included in the IM software is the ability to easily see the presence of contacts, i.e. to see whether a chosen friend, co-worker or buddy is online and connected through the selected service. Instant Messaging (IM) differs from ordinary mail in the immediacy of the message exchange and also makes a continued exchange simpler than sending e-mails back and forth.

The IM exchange can take various forms and be for one-to-one communication or for group communication. One-to-one communication is when one user engages in a communication session with only one recipient. Group communication refers to more than two participants engaging in a communication session.

The exchanges could be for example Push to Talk (PTT) or IM chat. PTT provides voice over IP communications for mobile users. It is a quick, one way communication service for short interactions in a one-to-one or one to many recipients' session. IM chat is text or voice messaging carried out in real time.

Currently, in group communications, an ad-hoc group can be created via the XCAP (XML Configuration Access Protocol) which allows a client application to read, write, and modify configuration data related to the communication group. When a group is inexistent, a user can still initiate a call by individually selecting callees, and initiating a group communications therewith. The group communication session takes place and on termination of the session, if any of the participants involved in the session wishes to save a pre-defined group including the list of participants involved in the session, the user would have to independently create such group.

Although there is no prior art alike the present invention, the US Patent Publication no. 2002/0110225 to Cullis bears some relation with the field of the present current invention. This US publication describes functionality for saving a telephone number in an address book at either the user or recipient's request. However, the aforementioned publication only describes saving a telephone number in an address book subsequent to a termination of a given communication, for either the user or recipient's future use, and stops short of describing the features which are part of the present invention.

Reference is made to FIG. 1 (Prior Art), which is a flowchart diagram of a call established between a user and a group of recipients according to today's state of the art. The user initiates the call (action 102) and decides to call recipient one (action 104), two (action 106) and three (action 108). The call takes place (action 110) and after it is terminated (action 112); both the user and recipients are asked if they want to save the telephone numbers of the call recipients in their address book, or not (action 114). If the answer is yes, the numbers will be individually saved in their address book (action 116). At a later time, if either the user or one of the recipients decides to initiate a call to the same recipients (action 118), then he/she will have to individually select each telephone number of each recipient from his/her address book (alike in actions 104, 106, 108).

As it can be seen, the prior art method for carrying out a group communication is cumbersome, as it requires manual definition of a communication group, or the individual selection of recipient's telephone numbers. This is awkward for many users, especially when group communications need to be carried out repetitively, or with a large number of recipients. In particular, it is especially arduous for mobile users to use the small keypads and/or displays of their mobiles to repetitively select individual callees' Ids from their contact books, or dial multiple phone numbers, in order to establish group calls.

There is therefore no known way at present to assist a user with the creation of communication group that can be automatically and persistently stored for subsequent use.

### SUMMARY

Accordingly, in order to overcome the shortcoming of the current solutions, it would be beneficial to provide a method and server for the automatic creation by the communications network of a communications group whereby each participant is given the option to store said communications group in his/her address book. The present invention provides such a method and server.

In one aspect, the invention is a method for the creation by the communication network of a communication group based on an ad-hoc group of participants. The group that is created is given a group identifier (ID) and is sent to the communication group. Thereafter any of the communication group participants can use the ID for carrying out future group communication sessions.

In another aspect the invention is a server for detecting a group communication and the subsequent creation of a communication group with an ID.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a flow diagram illustrating the steps of setting up a group call according to a known prior art scheme;

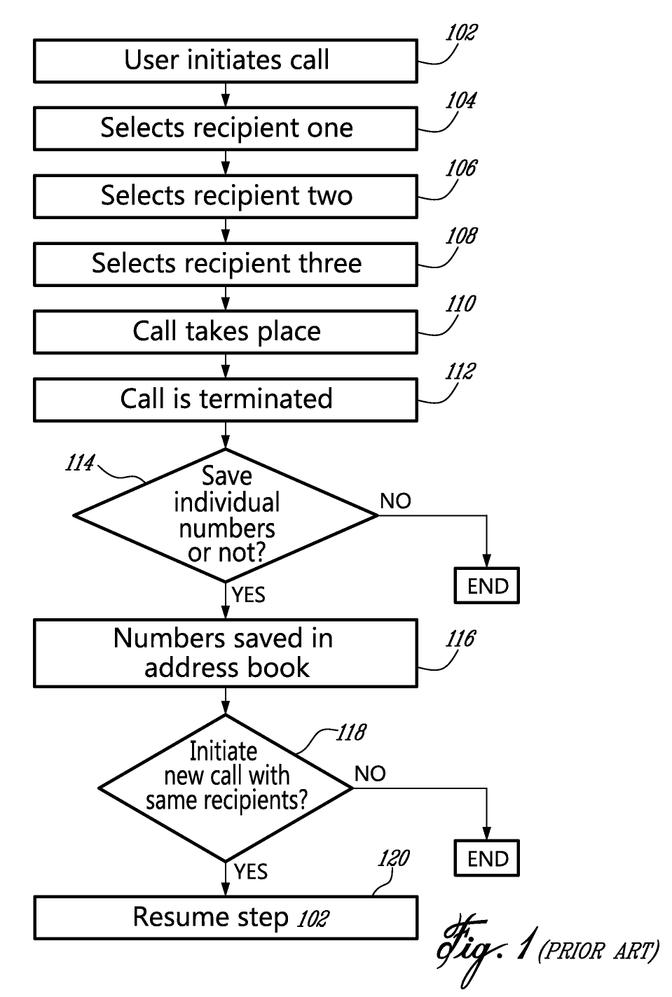

FIG. 2 is an exemplary network diagram of an IP Multimedia Subsystem (IMS) network containing a variant of the preferred embodiment of the present invention;

FIG. 3 is an exemplary diagram of a message structure according to a variant of the preferred embodiment of the present invention.

FIG. 4 is an exemplary flowchart diagram of a method for setting up a group call according to a preferred embodiment of the present invention.

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

According to the present invention and its related preferred embodiments, there is provided a method, a system and a telecommunications node that assists a user in the persistent creation of a communication group. The invention allows the creation by the network of a communication group based on the individual participants to a group communication session. According to the invention, when a user initiates a group communication (e.g. group call, multi-party conference, IM chat, SMS/MMS/IMS message broadcast or the likes), participants are first selected, and when establishing the communication, during the session, or at session termination, the network can automatically create the group with the participants, assign a group identifier to the group, and transmit the group identifier to the recipients for storage and subsequent use. Upon receipt of the group identifier, the participants can use that identifier in order to facilitate future group communications.

In the context of the present invention, the term communication may designate various types of communications, including but being not limited to message-based communications alike SMS/MMS/IMS/IM/email communications, or session-based communications where actual sessions are established and held for a given period of time, such as for example voice-based communications sessions, videoconferencing communications sessions, and the likes.

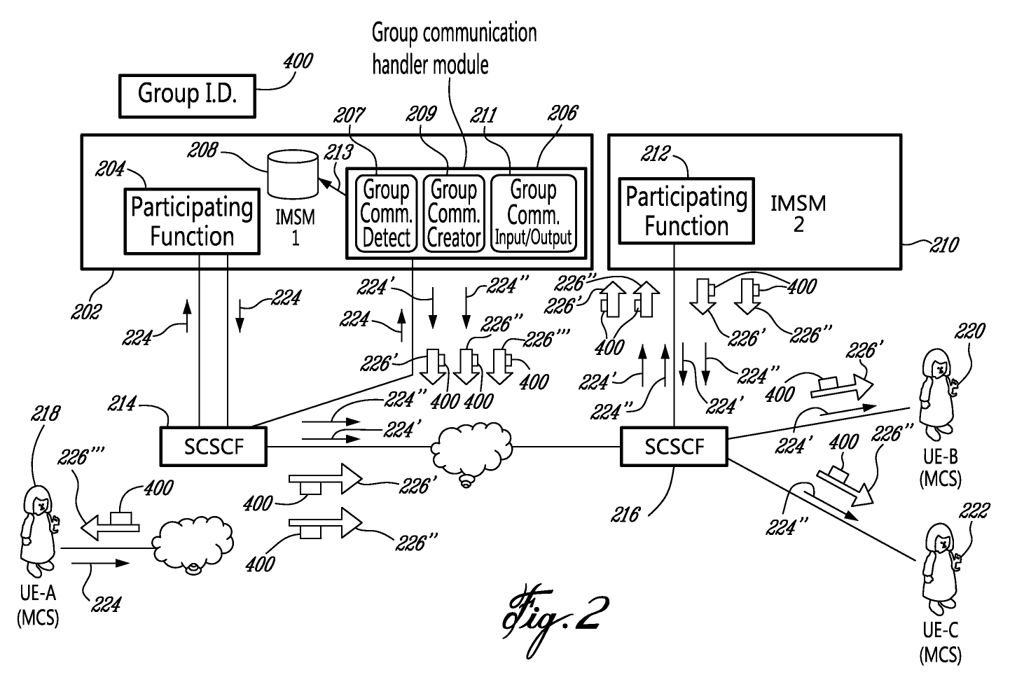

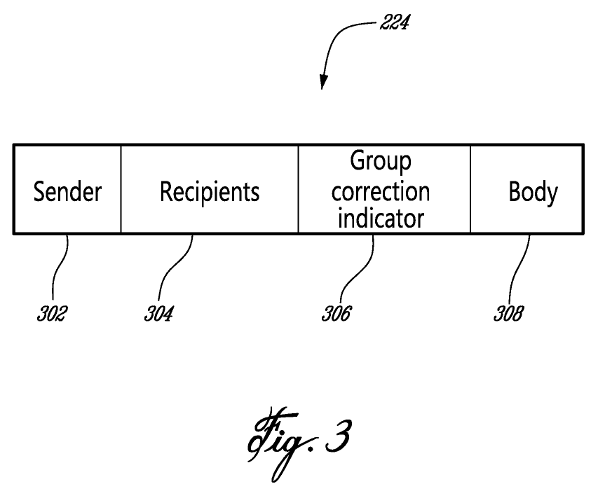

Reference is now made to FIG. 2, which shows an exemplary nodal operation and block diagram of an exemplary variant of the preferred embodiment of the invention. Shown in FIG. 2, is an IP Multimedia Subsystem IMS network (200) where the present invention can be implemented, although it is to be understood that this is only an exemplary scenario, and that the invention can be advantageously implemented in various types of networks. This exemplary scenario describes how an IMS message group communication can be carried out wherein an IMS messaging server can assist in the creation of a communication group, whose identifier is propagated then from the server to the participants to the group communication, so that it can be stored by the end-user terminals for later use. The IMS network 200 contains a first communication server, such as for example an IMS-Messaging Server, IMS-M #1 (202) whose function is to support IMS messaging services for User Equipments (UEs), alike the UE-A (218). The IMS-M #1 (202) further comprises a Participating Function, PF (204) as defined by OMA IM (Open Mobile Alliance Instant Messaging), a Group Communication Handler Module (206) adapted to support group communications. For this purpose, the communication handler module comprises a Group Communication Detector (207), a Group Communication Creator (209) a Group Communication Input/Output (211), and a Database (208), which functions will shortly be described for the storage of the group communication participants and identifier. The IMS network 200 further includes a second communication server, such as an IMS-Messaging Server IMS-M #2 (210) which provides messaging services for users UE-B (220) and UE-C (222). The IMS-M #2 (210) comprises a Participating Function, PF (212) as defined by OMA IM. Further on the other communication side is an S-CSCF (216), Serving Call State Control Function, (214) which is a node for routing the request of the participants. In the exemplary scenario of FIG. 2, the IMS UE-A (218) composes and sends an Instant Message (IM) intended for 2 other IMS recipients, UE-B (220) and UE-C (222). In this embodiment, the IM message is a SIP MESSAGE message (224). With reference being temporarily made to FIG. 3, which is a variant of the present invention, the SIP Message message (224) contains a sender (302), recipients (304), optionally, a Group Creation Indicator (306) and a body (308). The sender (302) is the person who initiates the message communication, in the present invention UE-A (218), the recipients are the users who receive the message UE-B (220) and UE-C (222), the Group Creation Indicator (306) lets the network know that a Group is to be created upon receipt of the message (224), and the body (308) is the message content that is being sent. The SIP MESSAGE message (224) is sent from the UE-A (218) to the S-CSCF (214). Once the S-CSCF (214) receives the SIP MESSAGE message (224), the S-CSCF (214) may analyze the Accept-Contact header and looks for the OMA (Open Mobile Alliance) feature tag (i.e., +g.oma.sip-im). Once found, the S-CSCF (214) routes the message to the IMS-M Server (202). If not found, the message is discarded.

The PF (204) receives all the SIP MESSAGE messages and is in charge to inspect the SIP message headers. Once successfully done, the PF (204) first verifies the sender's user preferences to determine if the sender is allowed to send an IM message. If not allowed, the PF (204) rejects the message and sends back the appropriate error response. If allowed, the PF (204) proceeds to determine where the message has to be routed and subsequently forwards the SIP MESSAGE message (224) to the Group Communication Handler Module (206) for further handling. The S-CSCF (214) proxies the message coming from the PF (204) direct to the Group Communication Handler Module (206). The Group Communication Handler Module (206) receives the SIP MESSAGE message (224). After analyzing each address the Group Communication handler module (202) may create copies (224′, 224″) of the original SIP MESSAGE message (224′) for each IMS recipient in the recipient list, i.e. for the UE-B (220) and UE-C (222) and send them to the intended recipients. Each of the new SIP MESSAGE message (224′ and 224″) is destined to one of the two intended recipients so that it is proxied by the S-CSCF (214) to the S-CSCF (216) for further analysis.

The Participating Function PF (212) receives all the SIP MESSAGE messages (224′ and 224″) and is in charge to inspect the SIP message headers. Once successfully done, the PF (212) first verifies the receiver's user preferences to determine if the receiver is allowed to receive IM messages. If not allowed, the PF (212) rejects the message and sends back the appropriate error response. If allowed, the PF (212) proceeds to determine where the message has to be routed and subsequently forwards the SIP MESSAGE (224′ and 224″) to the S-CSCF (216) where it will be sent to the end-user (based on the Request—URI) for further handling.

The SIP MESSAGE message (224′, 224″) is sent by the S-CSCF (216) and finally received by each intended recipient (i.e., UE-B (220) and UE-C (222)).

Although not shown in FIG. 2 for simplicity purposes, recipients UE-B (220) and UE-C (222) each return a SIP 200 OK message to the S-CSCF (216). The S-CSCF (216) proxies all SIP 200 OK messages over to the PF (212). The PF (212) proxies all SIP 200 OK messages through to the S-CSCF (216) for further handling. The SIP 200 OK message is proxied back to the network for further handling. In order to close out the loop for each SIP MESSAGE message (224′, 224′) that was initiated by the Group Communication Handler Module (206), a SIP 200 OK is needed. As a result, the S-CSCF (214) forwards all received SIP 200 OK messages to the Group Communication Handler Module (206) in order to acknowledge that each UE has successfully received each SIP MESSAGE message (224′, 224″).

In parallel with the receipt of the SIP 200 OK messages (i.e., one 200 OK message for each SIP MESSAGE message that was sent out), the Group Communication Handler Module (206), initiates the group creation. Alternatively, the Group Communication Handler Module (206) can initiate the group creation upon detecting the optional Group Creation Indicator (306), For example, upon receipt of the SIP MESSAGE message (224) by the Group Communication Handler Module (206), the Group Communication Detector (207) may detect in the SIP MESSAGE message (224′) the Group Communication Indicator (306), which triggers the formation of the communication group by the Group Communication Creator module (209). Thus, the Group Communication Creator module (209) acts to gather the participants list that includes all participants to the communication, i.e. UE-A (218), UE-B (220), and UE-C (222), and put these identities into a communication group, assigns it an alias name, i.e. a group identifier name, and then issues to the Group Identifier storage (208) a Group Identifier message (213) containing the communication group as just created. This Group Identifier Message (213) tells the Group Identifier Storage (208) to store the communication group. Once the communication group is successfully created, an advertising group message (226) containing the group identification (400) is sent out to all IMS group participants in order to inform them that the group has been created with its own unique Group ID. The advertising group message (226′, 226″, 226′″) is sent from the Group Communication Handler Module (206) to the S-CSCF (214). One advertising group message (226′″) is returned to the sender UE-A (218) whilst the other two advertising group message (226,′ 226″) are forwarded to the S-CSCF (216). The Participation Function (212) receives the advertising group messages (226′, 226″) and forwards them to the S-CSCF (216). Thereafter the advertising group message (226′, 226″) containing the group identification (400) is sent to recipients UE-B (220) and UE-C (222).

Although not shown in FIG. 2 for simplicity purposes, meanwhile, the Group Communication Handler Module (206) then sends back to the sender (i.e. UE-A (218)) a SIP 202 Accepted response. The S-CSCF (214) receives and proxies the SIP 202 Accepted message over to the PF (204) for further handling. The PF (204) receives and proxies the SIP 202 Accepted message back to the S-CSCF (214) for further handling. The S-CSCF (214) receives and finally forwards the SIP 202 Accepted message over to the original sender (i.e., UE-A (218)), thereby closing out the complete flow for the original SIP MESSAGE message (224) that was sent.

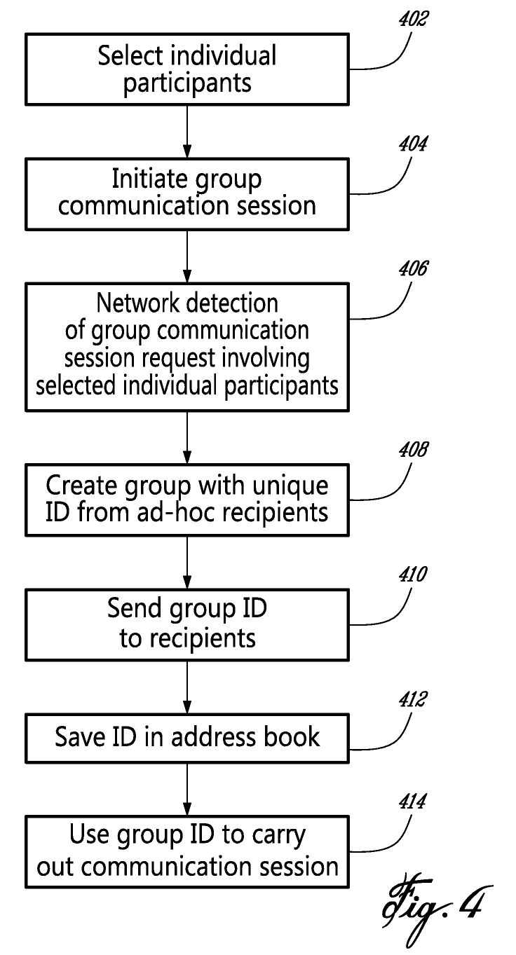

Reference is now made to FIG. 4, which shows an exemplary flow chart of one of the embodiments of the present invention. The user first selects a number of individual recipients or participants for a group communication (action 402) and initiates that group communication session (action 404). A communication server in the network detects the group communication session request (action 406) and creates a communication group from the number of individual recipients with its own unique group identifier (action 408).

The network then sends the group identifier to the group of participants (action 410) giving the option to each one to save the group identifier in his/her individual address books (action 412). The recipients will thereafter be able to use the new group identifier, instead of all the individual numbers, to carry out future communication sessions (action 414).

Although the exemplary embodiments of the present invention have been mainly described with reference to message communications, such as the SIP MESSAGE message communication, it is to be understood by those skilled in the art that the application of the present invention is not limited to the transmission of SIP messages to a communication group. For example, with reference being now made back to FIG. 2, the message communication (224) initiated by the UE-A(218) towards the UE-B (220) and UE-C (222) may be a voice group communication, a video conferencing communication, or any other type of communication, where a server (202), upon detection of a group communication setup, can act in order to create the communication group, as described, store, and distribute in actions (226) the communication group identifier (400) to the communication's participants.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for creating a communication group, the method comprising the steps of:
detecting a group communication involving a plurality of individual participants;
creating a communication group that comprises a group identifier and identities of the plurality of individual participants; and
sending the group ID to the individual participants.

2. The method claimed in claim 1, wherein the detecting step takes place in a communication network.

3. The method claimed in claim 2, wherein the network comprises an IMS network.

4. The method claimed in claim 1, wherein the group communication is a group message communication.

5. The method claimed in claim 4, wherein the group communication is an IMS (IP Multimedia Subsystem) message.

6. The method claimed in claim 4, wherein the group communication is an IM (Instant Message) communication.

7. The method claimed in claim 4, wherein the group communication is an e-mail message communication.

8. The method claimed in claim 4, wherein the group communication is an SMS (Short message Service) message communication.

9. The method claimed in claim 1, wherein the group communication is multi-party voice call communication.

10. The method claimed in claim 1, wherein the group communication is a multi-party videoconferencing communication.

11. The method claimed in claim 1, further comprising the step of:
using the group identifier for a subsequent group communication.

12. The method claimed in claim 1, wherein the group participants includes the sender of the group communication.

13. A communication server comprising:
a group communication detector detecting a group communication involving a plurality of individual participants;
a group communication creator creating a communication group in response to a detection of the group communication, the communication group comprising a group identifier and the plurality of individual participants; and
a group communication Input/Output (I/O) interface that sends the group identifier to the individual participants.

14. The communication server claimed in claim 13, further comprising;
a data storage for storing the communication group.

15. The data storage claimed in claim 14, wherein the storage receives a Group Identifier Message from the Group Communication Creator instructing to store the communication group.

16. The communication server claimed in claim 13 further comprising a participating function that verifies the participant, and when the participant is successfully verified, forwards the Group Communication via an S-CSCF (Serving Call State Control Function) to the Group Communication Handler Module.

17. The participating function claimed in claim 16 wherein if the participating function does not verify the participant the group communication is rejected and an error message is sent to the participant via the S-CSCF.

18. The communication server claimed in claim 13, wherein the group communication is an IMS (IP Multimedia Subsystem) communication.

19. The communication server claimed in claim 13, wherein the group communication is an IM (Instant Message) communication.

20. The communication server claimed in claim 13, wherein the group communication is an e-mail message communication.

21. The communication server claimed in claim 13, wherein the group communication is SMS (Short Message Service) message communication.

22. The communication server claimed in claim 13, wherein the group communication is multi-party voice call communication.

23. The communicating server claimed in claim 13, wherein the group communicating is a multi-party videoconferencing communication.
